(19) United States
(12) Patent Application Publication
(10) Pub. No.: US 2024/0302152 A1
(43) Pub. Date: Sep. 12, 2024

(54) Professional Drywall Measuring Tape

(71) Applicant: Joseph Micheal Leclerc, London (CA)

(72) Inventor: Joseph Micheal Leclerc, London (CA)

(21) Appl. No.: 18/178,691

(22) Filed: Mar. 6, 2023

(51) Int. Cl. G01B 3/1041

(52) U.S. Cl. CPC G01B 3/1041; G01B 2003/1053

(57) ABSTRACT

A modification to a standard measuring tape which includes a sliding piece of material which moves within the body of the measuring tape but does not detach.

### BACKGROUND OF THE INVENTION

The current and best techniques used by professional drywall installers cause abrasions and cuts to the hands. It's somewhat cumbersome to use these methods. However they are the quickest way to cut the drywall for installation. This Item works in line with those techniques, using familiar tools, and materials.

### SUMMARY OF INVENTION/CLAIMS

This enhanced measuring tape is specifically designed for use in the construction industry, to make drywall cutting, using professional techniques, easier, more accurate, and to reduce the risk of damage to hands. Essentially the additional piece acts as a guard for the index finger when sliding along a workpiece. This piece can be static or dynamic(moving in and out of the body of the measuring tape). Pinching the measuring tape against the added piece creates a more stable brace, which holds, more firmly the desired measurement. Given the barrier that the piece creates, it protects the index finger of the user from abrading on the workpiece.

### DESCRIPTION OF DRAWINGS

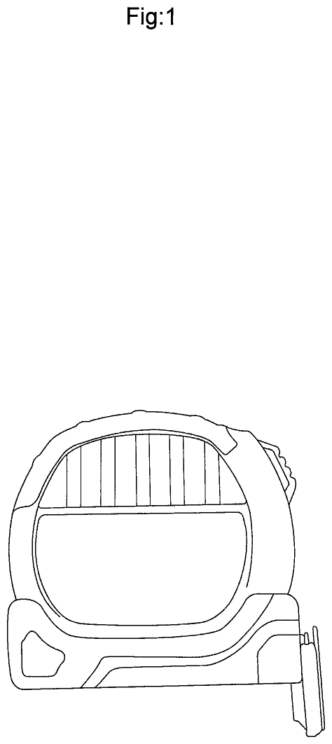

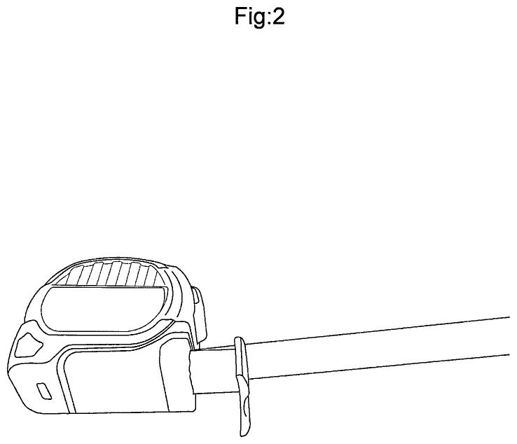

“Point A” This is a modification to a standard measuring tape. The first modification is at the body of the measuring tape, a plastic slide(guard) has been added under the actual tape. It is able to tuck away inside the body, and slide out when needed. This “guard” is pinched by the user against the tape, in order to get an accurate measurement. That “guard” is then slid down the edge of material, while the “knife” at the other end of the tape cuts the material farther down. The guard protects the fingers of the professional from abrasions, and slides easier along the material than the skin of the finger does. This can be seen in FIGS. 1 and 2.

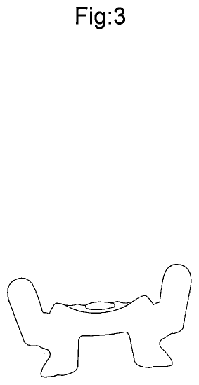

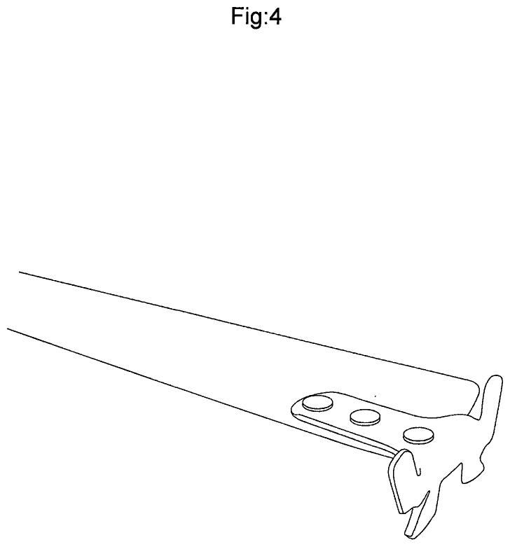

“Point B” The second modification to the standard measuring tape is to what is commonly referred to as the “hook”. That is the piece at the end of the tape that pulls out. That modification is to make a slight point on the bottom(convex side) of the hook, and slightly sharpen it. The point is meant to fit into a modified or standard knife, for stability. This can be seen in FIGS. 3 and 4.

1. This enhanced measuring tape is specifically designed for use in the construction industry, to make drywall cutting, using professional techniques, easier, more accurate, and to reduce the risk of damage to hands. Essentially the additional piece acts as a guard for the index finger when sliding along a workpiece. This piece can be static or dynamic(moving in and out of the body of the measuring tape). Pinching the measuring tape against the added piece creates a more stable brace, which holds, more firmly the desired measurement. Given the barrier that the piece creates, it protects the index finger of the user from abrading on the workpiece.
